(19) United States
(12) Patent Application Publication
(10) Pub. No.: US 2016/0332241 A1
(43) Pub. Date: Nov. 17, 2016

(54) MILL CUTTER ASSEMBLY

(71) Applicant: HSIAO -LIN LIU, Taipei City (TW)

(72) Inventor: HSIAO -LIN LIU, Taipei City (TW)

(21) Appl. No.: 14/711,791

(22) Filed: May 14, 2015

(51) Int. Cl. B23C 5/26; B23C 5/10

(52) U.S. Cl. CPC B23C 5/26; B23C 5/10; B23C 2210/02

(57) ABSTRACT

A mill cutter assembly comprises a handle having a tapered hole and a through hole; an upper end of an connecting block having a threaded hole; a lower bottom of the connecting block being formed with an engaging groove; a knife having a lower portion and the lower portion being formed with a helical trench and a helical cutting portion; an upper end of the knife being formed as an engaging section which can be inserted into the tapered hole of the handle; an outer side of the engaging section having a tapered shape; an upper side of the engaging section being formed with an engaging block which is engagable with the engaging groove of the connecting block; and a stud having a head and a shaft extended downwards from a lower side of the head; the stud having a straight rod and a threaded rod.

### FIELD OF THE INVENTION

The present invention relates to mill cutters, and in particular to a mill cutter assembly which is cost downed and has a preferred hardness.

### BACKGROUND OF THE INVENTION

With reference to FIG. 1, a prior art mill cutter is illustrated. The prior mill cutter has a round cylindrical tungsten body. A frontend of the body is machined to have a plurality of screwing trenches for fixing a handle 10 and a knife 11. In working, only the knife 11 is used and therefore, it is only necessary that the knife 11 is made of hard tungsten for cutting effectively, while the handle 10 is unnecessary to be hard. If the handle 10 is made of tungsten, the cost will be unnecessarily increased.

With reference to FIG. 2, to improve the problem in the prior art, in the improving structures, the handle 12 and the knife 13 are made integrally. Then a layer of tungsten is added to the knife 13 to form as a hard layer 14. Therefore, the cost can be down greatly and the hard layer 14 provides suffice hardness to the knife 13. However, to add a hard layer 14 to the knife 13 is complicated and tedious, as well as the cost cannot be reduced greatly.

With reference to FIG. 13, another design is disclosed. In this structure, the handle 15 is made of general steel and the knife 16 is made of tungsten. A lower end of the handle 15 is formed with a screw hole 17 and an upper end of the knife 16 has a threaded post 18 for engaging with the screw hole 17 of the handle 15. This structure can save cost greatly. However, in this structure, since the hardness difference between the handle 16 and the knife 15 is great and, the threads of the threaded post 18 are small and easy to break so as to affect the combination between the knife 16 and the handle 15.

### SUMMARY OF THE INVENTION

Accordingly, to improve above mentioned prior art defects, the present invention, provides a mill cutter assembly, which is a low cost cutter and has a preferred hardness structure.

To achieve above object, the present invention provides a mill cutter assembly comprising: a handle having a tapered hole at a lower end thereof and a through hole at an upper end thereof; a connecting block; an upper end of the connecting block having a threaded hole; a lower bottom of the connecting block being formed with an engaging groove which is formed with a large bottom and a small opening; a knife having a lower portion and the lower portion being formed with a helical trench and a helical knife portion; an upper end of the knife being formed as an engaging section which can be inserted into the tapered hole of the handle; an outer side of the engaging section having a tapered shape; an upper side of the engaging section being formed with an engaging block which is engagable with the engaging groove of the connecting block; and a stud having a head and a shaft extended downwards from a lower side of the head; the stud having a straight rod and a threaded rod extended from a lower end of the straight rod; a lower portion of the threaded rod being formed with thread.

### BRIEF DESCRIPTION OF THE DRAWINGS

FIG. 1 is a schematic cross sectional view of a prior art mill cutter.

FIG. 2 is a schematic cross sectional view of another prior art mill cutter.

FIG. 3 is a schematic cross section view of a prior assembled mill cutter.

FIG. 4 is an exploded perspective view of the first embodiment of the present invention.

FIG. 5 is a plane exploded perspective view of the first embodiment of the present invention.

FIG. 6 is an assembled perspective view about the first embodiment of the present invention.

FIG. 7 is a cross sectional view about the assembly of the first embodiment of the present invention.

FIG. 8 is an assembled schematic view about the first embodiment of the present invention.

FIG. 9 is an assembled schematic cross section view of the detaching unit of the present invention.

FIG. 10 is a schematic view showing the detaching action in the first embodiment of the present invention.

FIG. 11 shows the second embodiment of the present invention.

FIG. 12 shows the third embodiment of the present invention.

FIG. 13 is an exploded schematic view about the fourth embodiment of the present invention.

FIG. 14 is an assembled schematic cross section view about fourth embodiment of the present invention.

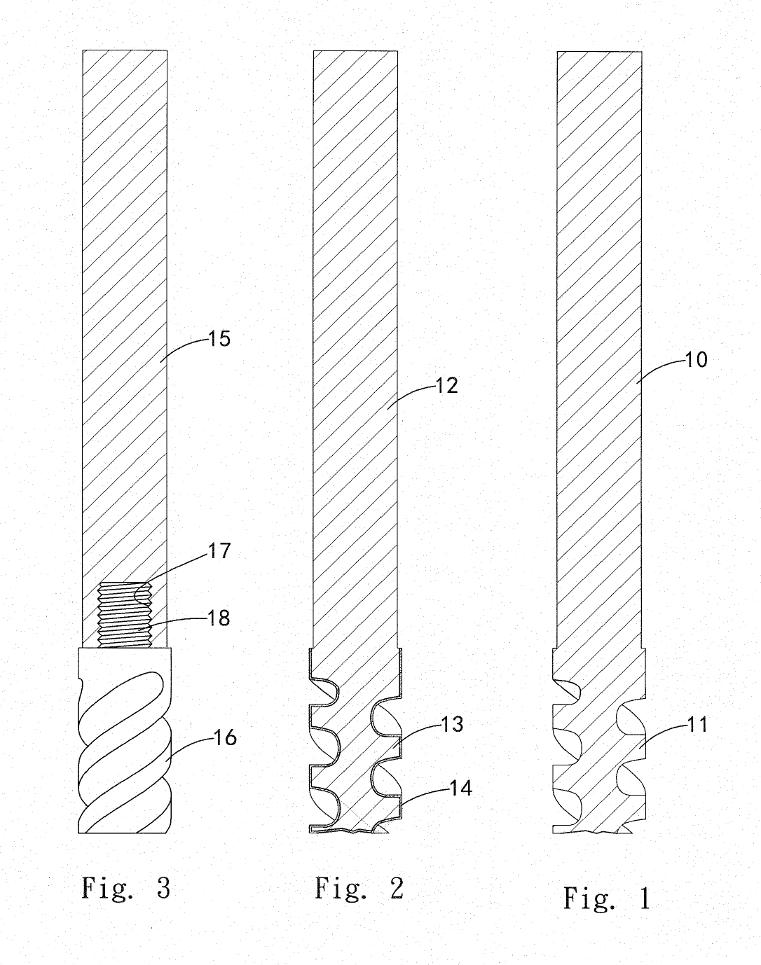

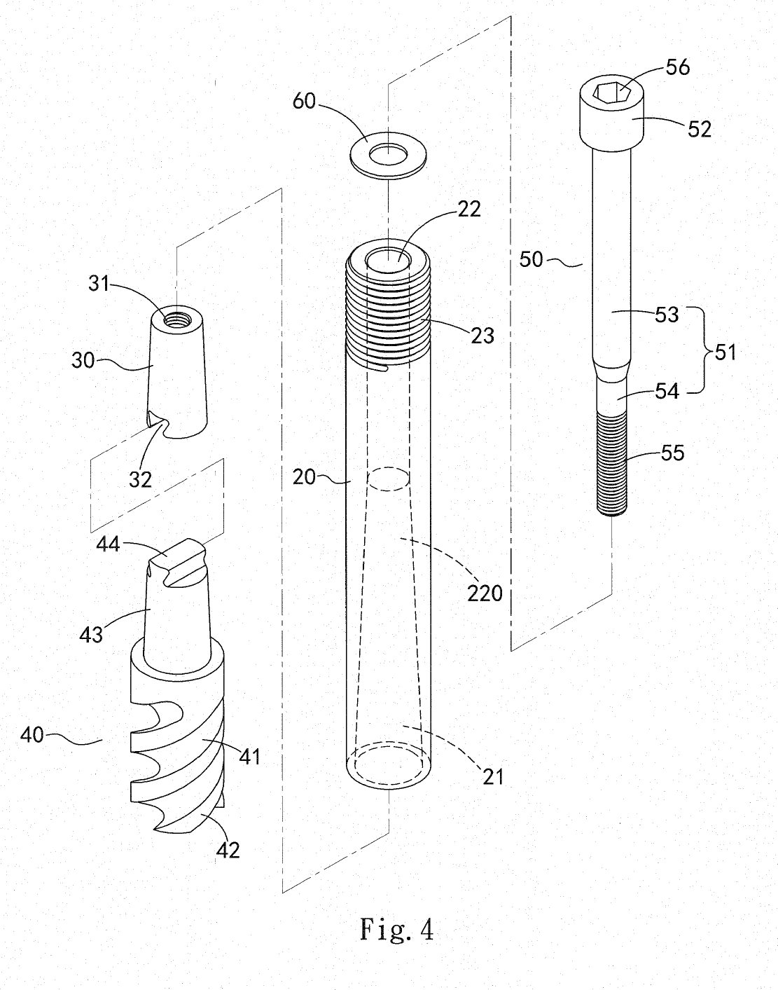

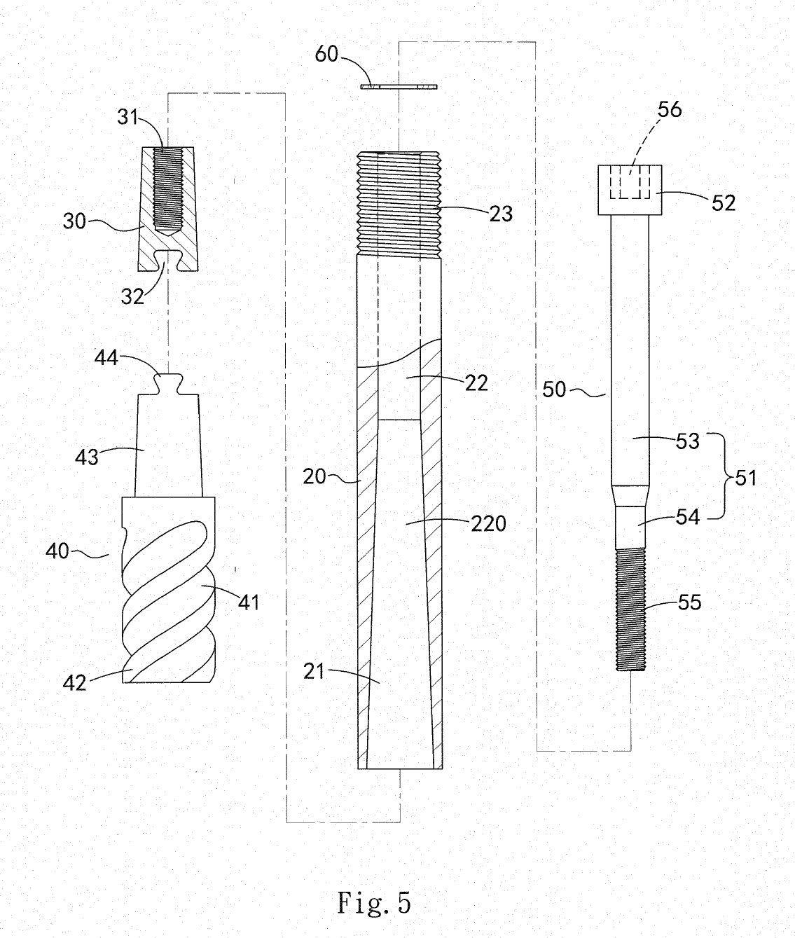

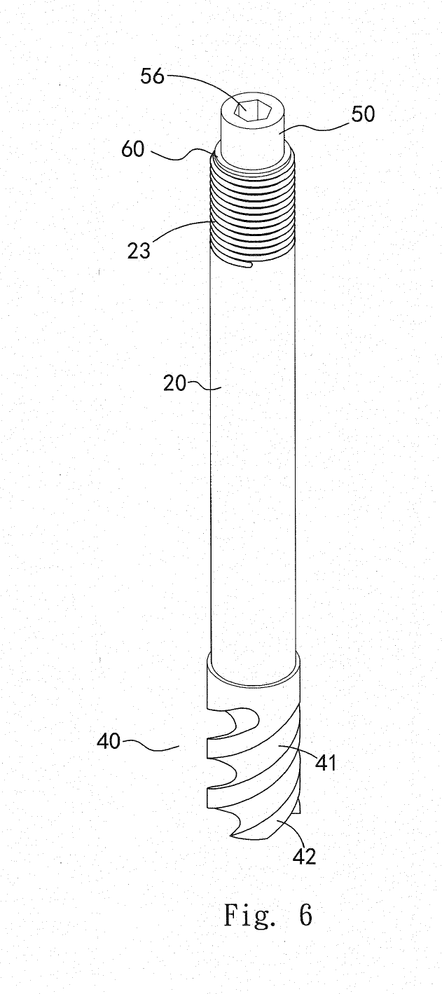

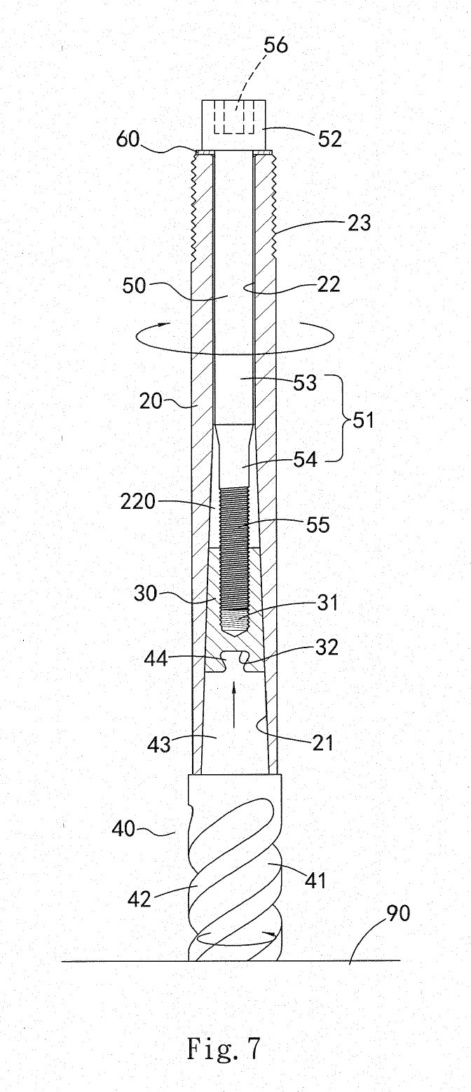

### DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A handle 20 has a tapered hole 21 at a lower end thereof and a tapered hole 21 is a via hole 220 which is communicated to the through hole 22. A slope of the tapered hole 21 is 1.5 degrees with respect to a central axis thereof. The via hole 220 has a tapered shape and has a slope of 1.5 degrees with respect to a central axis thereof.

A connecting block 30 has a tapered shape with a slope of 1.5 degrees. An upper end of the connecting block 30 has a threaded hole 31. A lower bottom of the connecting block 30 is formed with an engaging groove 32 which is formed as a dovetail shape with a large bottom and a small opening. However, the engaging groove 32 may have a T shape or other shape.

A knife 40 has a lower portion and the lower portion is formed with a helical trench 4 and a helical knife portion 42. An upper end of the knife 40 is formed as an engaging section 43 which can be inserted into the tapered hole 21 of the handle 20. An outer side of the engaging section 43 has a tapered shape with a slope of 1.5 degrees with respect to a central axis thereof. An upper side of the engaging section 43 is formed with an engaging block 44 which is engagable with the engaging groove 32 of the connecting block 30.

A stud 50 has a head 52 and a shaft 51 extended downwards from a lower side of the head 52. The stud 50 has a straight rod 53 and a threaded rod 54 extended from a lower end of the straight rod 53. A lower portion of the threaded rod 54 is formed with thread 55. An upper end of the head 52 has a polygonal groove 56 (for example, a hexagonal groove, etc.) for receiving a rotating tool 80 (for example, a hexagonal spanner, etc.) to drive itself.

A washer 60 has a round shape and is installed to be around the shaft 51 of the stud 50 and is between the head 52 and an upper end of the handle 20.

In the present invention, the knife 40 is a separable assembly and is made of high hardness material, such as tungsten steel, etc. so as to have preferred cutting effect. Furthermore the handle 20, the connecting block 30 and the stud 50 may made of low cost steel so that the whole cost is reduced greatly.

Especially, the engaging block 44 of the knife 40 is engaged into the engaging groove 32 of the connecting block 30 to assembly the knife 40 to the connecting block 30. Therefore, in operation, although the hardness difference between the knife 40 and the connecting block 30 is great, the cutter will not break. Furthermore since the connecting block 30 and the stud 50 are made of same material, the thread of the threaded hole 31 will not be destroyed due to the hardness difference between the connecting block 30 and the stud 50. Therefore, the structure of the present invention provides a preferred combining strength.

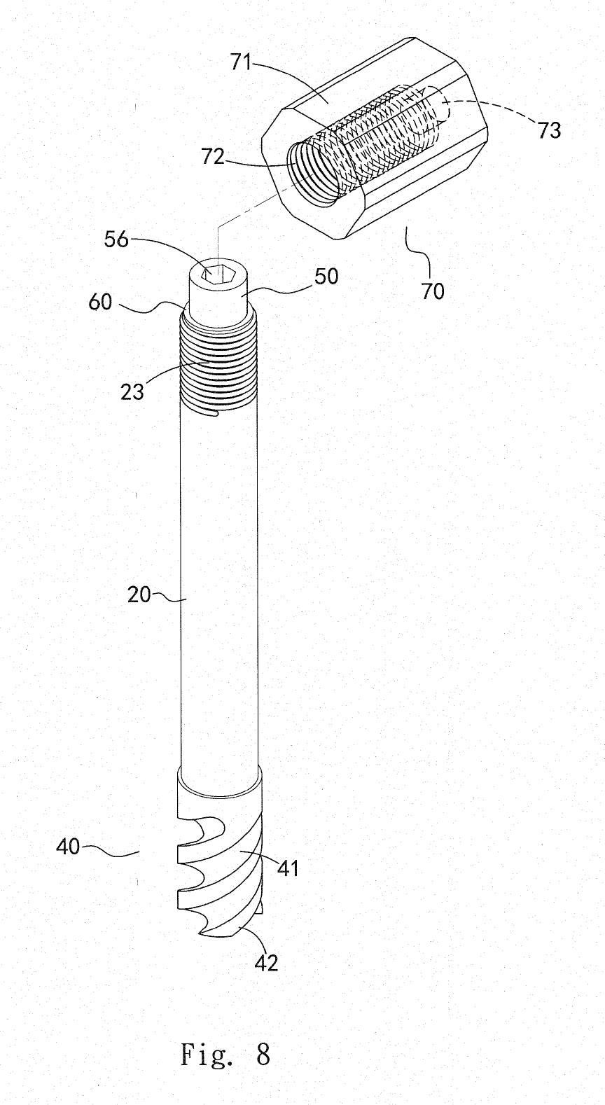

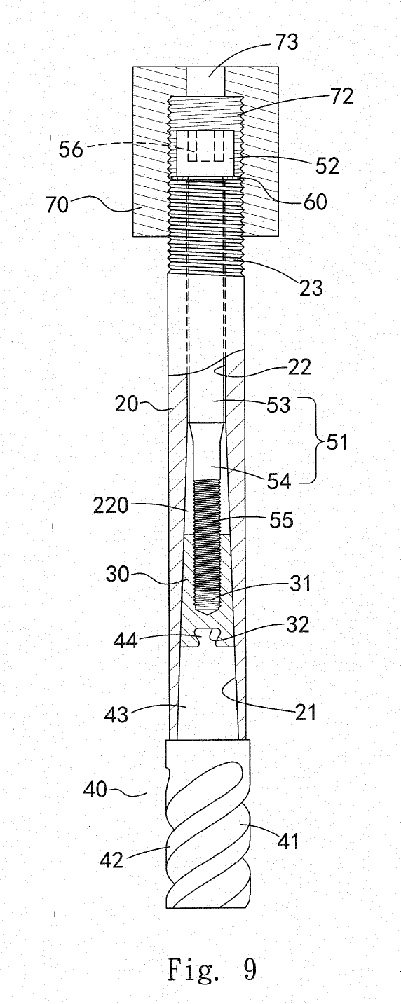

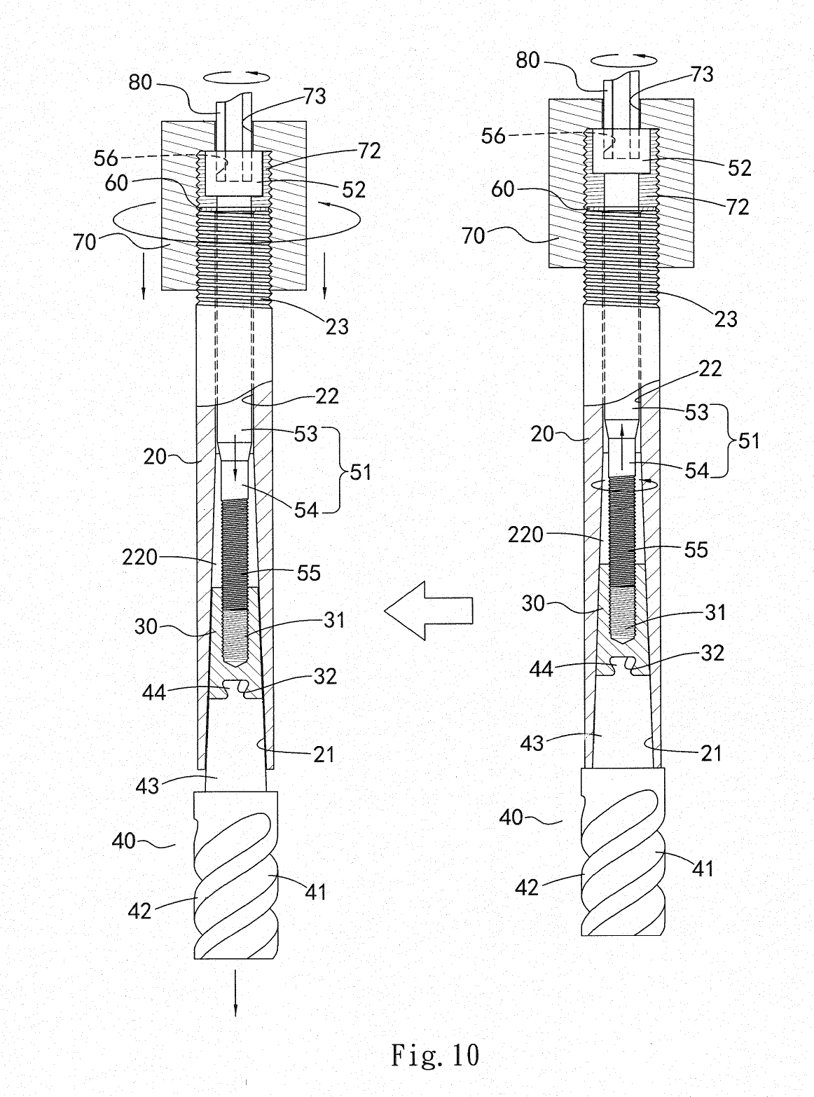

With reference to FIGS. 8 to 10, the present invention further comprises a detaching unit 70. The detaching unit 70 has a detaching screw hole 72 at a lower side thereof and a via hole 73 at an upper side thereof. An outer side of the detaching unit 70 is formed with a plurality of planes 71. The detaching unit 70 may have a rectangular cross section, a hexagonal cross section, or others. In assembly, the detaching screw hole 72 is engaged to an outer threaded section 23 of the handle 20 so that the detaching unit 70 is assembled to the handle 20. A size of the via hole 73 is smaller than the head 52 of the stud 50 so that a rotating unit 80 can pass therethrough.

Referring to FIG. 7, when the present invention is drilled into a work piece 90 clockwise, the knife 40 will suffer a counterclockwise reacting force from the work piece 90. By the engagement between the engaging block 44 and the engaging groove 32, the counterclockwise reacting force is transferred to the connecting block 30. Thereby, the connecting block 30 will be pulled into the tapered hole 21 due to the engagement relation between the threaded hole 31 of the connecting block 30 and the threaded portion 55 of the stud 50. As a result, the tapered surface of the engaging section 43 of the knife 40 is tightly adhered to the wall of the tapered hole 21 of the handle 20 to form a tightening locking state.

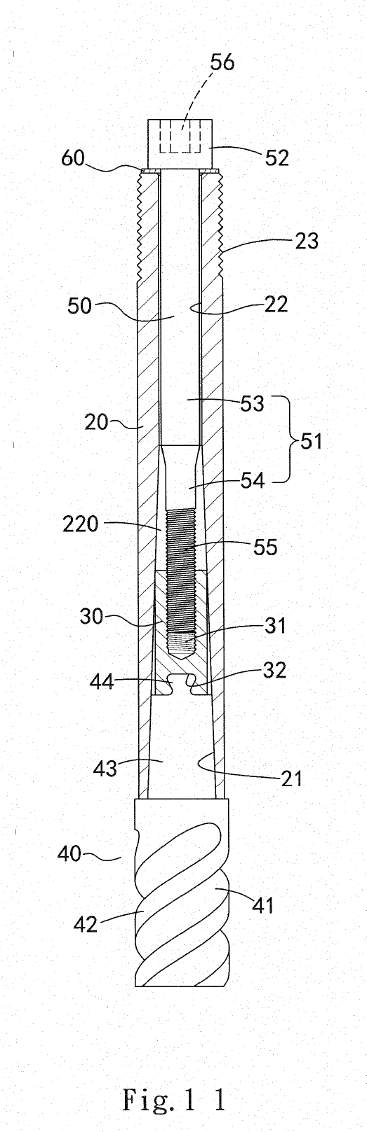

With reference to FIG. 10, when it is desired to detach the knife 40 from the work piece, the detaching screw hole 72 of the detaching unit 70 is engaged to the outer threaded section 23 of the handle 20. Then the rotating unit 80 passes through the via hole 73 to embed into the polygonal recess 56 at an upper side of the stud 50 to rotate it counterclockwise so that the threaded portion 55 of the stud 50 is screwed out from the threaded hole 31 until a top of the head 52 of the stud 50 tightly resists against a bottom of the detaching screw hole 72. Then the stud 50 is further rotated counterclockwise drive the detaching unit 70 to rotate counterclockwise by friction force, or directly by a clamping tool (not shown) to clamp the detaching unit 70 to rotate counterclockwise. By the thread engagement between the outer threaded section 23 of the handle 20 and the detaching screw hole 72 of the detaching unit 70, the handle 20 rotates along a direction toward the knife 40. Thus, the detaching unit 70 will eject the head 52 of the stud 50 so that a lower end of the stud 50 pushes the connecting block 30 and the knife 40 toward the tapered hole 21 so as to release the locking state. At this moment, the knife 40 can be rotated easily to drive the connecting block 30 to release from the stud 50.

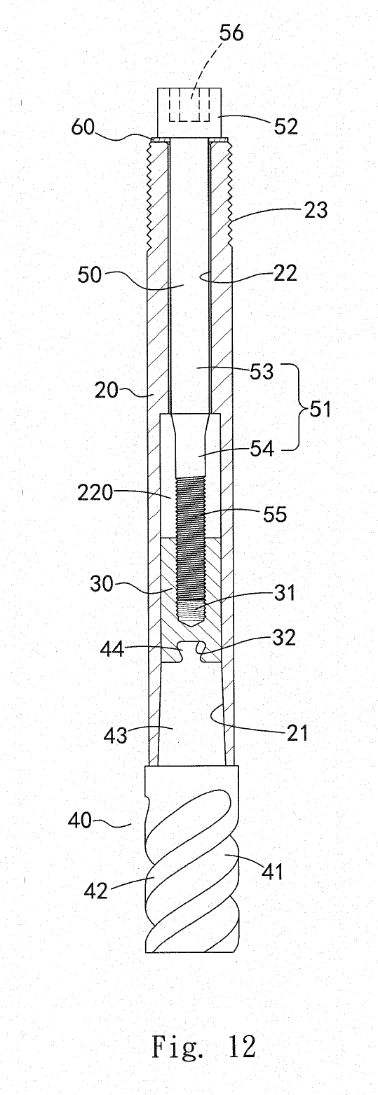

With reference to FIG. 11, the second embodiment of the present invention is illustrated. The structure of this embodiment is almost identical to those in the first embodiment, and thus those elements the same numerals have same functions as those described in the first embodiment. The difference is that the connecting block 30 has a round shape and an outer diameter thereof is smaller than an upper end of the tapered engaging section 43 of the knife 40.

With reference to FIG. 12, a third embodiment of the present invention is illustrated. The structure of this embodiment is almost identical to those in the first embodiment, and thus those elements identical by the same numerals have same functions as those described in the first embodiment. The difference is that the via hole 220 of the handle 20 has a cylindrical inner wall. The connecting block 30 has a shape corresponding to the cylindrical inner wall of the via hole 220 of the handle 20 so as to axially move along the via hole 220 of the handle 20.

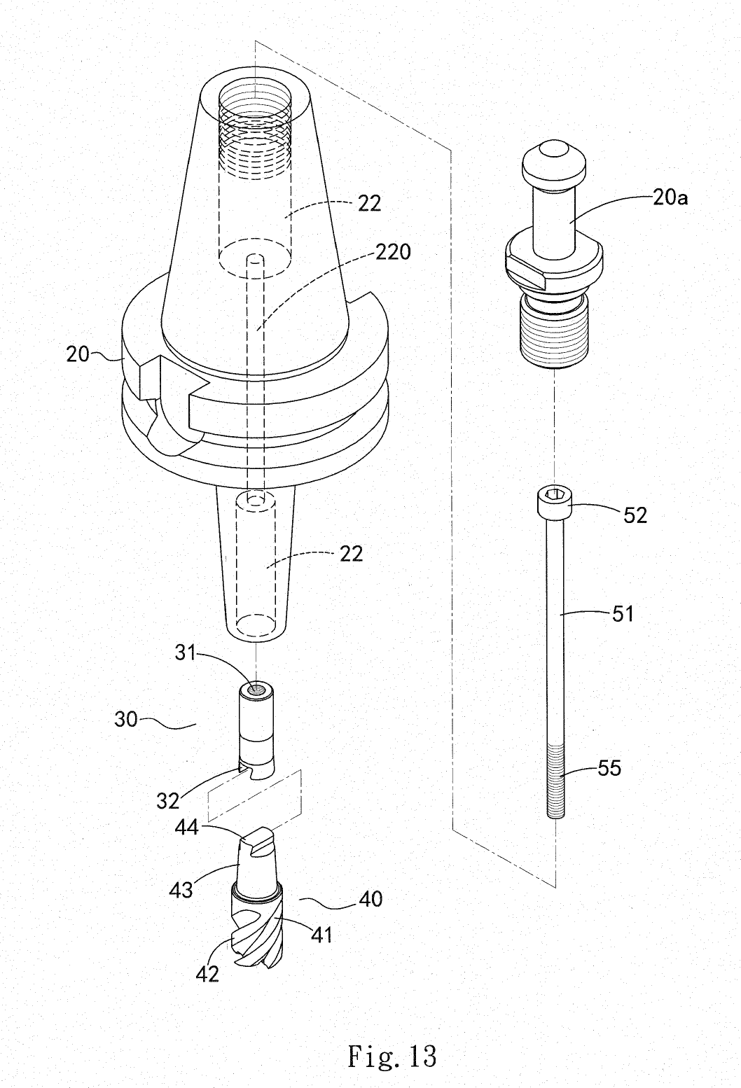

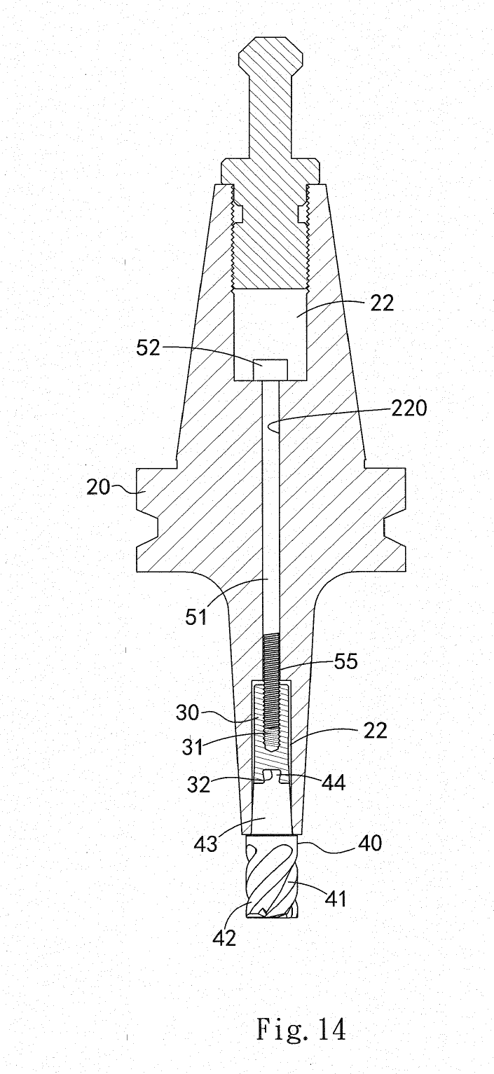

With reference to FIGS. 13 and 14, the fourth embodiment of the present invention is illustrated. The structure of this embodiment is almost identical to those in the first embodiment, and thus those elements identical by the same numerals have same functions as those described in the first embodiment. The difference is that the knife 40 has a shape like a knife in the prior art machining tool. That is, the connecting block 30, knife 40 and stud 50 can be directly applied to the prior art knife of a machining tool. A size of the through hole 22 of the handle 20 is greater than that of the via hole 220 of the handle 20 to receive the head 52 of the stud 50, and an upper end of the through hole 22 may be screwed with a knife stem 20a. The via hole 220 of the handle 20 has a round cylindrical shape for being passed by the stud 50.

The present invention is thus described, it will be obvious that the same may be varied in many ways. Such variations are not to be invention, and all such modifications as would be obvious to one skilled in the art are intended to be included within the scope of the following claims.

What is claimed is:

1. A mill cutter assembly, comprising:
a handle having a tapered hole at a lower end thereof and a through hole at an upper end thereof;
a connecting block; an upper end of the connecting block having a threaded hole; a lower bottom of the connecting block being formed with an engaging groove which is formed with a large bottom and a small opening;
a knife having a lower portion and the lower portion being formed with a helical trench and a helical cutting portion; an upper of the knife being formed as an engaging section which can be inserted into the tapered hole of the handle; an outer side of the engaging section having a tapered shape; an upper side of the engaging section being formed with an engaging block which engagable with the engaging groove of the connecting block; and
a stud having a head and a shaft extended downwards from a lower side of the head; the stud having a straight rod and a threaded rod extended from a lower end of the straight rod; a lower portion of the threaded rod being formed with thread.

2. The mill cutter assembly as claimed in claim 1, further comprising a detaching unit having a detaching screw hole at a lower side thereof and a via hole at an upper side thereof; and an outer side of the detaching unit is formed with a plurality of planes; and
an upper surface of the handle is formed with outer thread of which rotating direction is opposite to that of the thread at a lower portion of the threaded rod of the stud; the head of the stud is formed with a polygonal recess for receiving a rotating tool to drive it to rotate; and
wherein in assembly the detaching screw hole is engaged to an outer threaded section of the handle so that the detaching unit is assembled to the handle.

3. The mill cutter assembly as claimed in claim 2, further comprising a washer has a round shape and is installed to be around the shaft of the stud and is between the head and an upper end of the handle.

4. The mill cutter assembly as claimed in claim 1, wherein an upper end of the tapered hole of the handle is a via hole which is communicated to the through hole of the handle; the via hole of the handle has a tapered shape for receiving the connecting block to axially move therein.

5. The mill cutter assembly as claimed in claim 4, wherein a shape of the connecting block is corresponding to that of the via hole of the handle.

6. The mill cutter assembly as claimed in claim 4, wherein the connecting block has a round cylindrical shape and an outer diameter thereof is smaller than an upper end of the tapered engaging section of the knife.

7. The mill cutter assembly as claimed in claim 1, wherein a lower end of the tapered hole of the handle has a via hole which is communicated to the tapered hole thereof; and the via hole has a round cylindrical shape; the connecting block has a round cylindrical shape and is axially movable along the via hole of the handle.

8. The mill cutter assembly as claimed in claim 1, wherein the knife is made of tungsten; and the knife, the connecting block and the stud are made of steel.

9. The mill cutter assembly as claimed in claim 1, wherein the engaging groove is formed as a dovetail shape with a large bottom and a small opening.

10. The mill cutter assembly as claimed in claim 1, wherein the stud has a straight rod and a threaded rod extended from a lower end of the straight rod; a lower portion of the threaded rod is formed with thread.

11. The mill cutter assembly as claimed in claim 2, wherein a periphery of the detaching unit is formed with a plurality of planes for being clamped by a clamper.
